(19) United States
(12) Patent Application Publication
(10) Pub. No.: US 2022/0226852 A1
(43) Pub. Date: Jul. 21, 2022

(54) SPRINKLER SHROUD DEVICE

(71) Applicant: Lance Hostetler, Buhl, ID (US)

(72) Inventor: Lance Hostetler, Buhl, ID (US)

(21) Appl. No.: 17/581,680

(22) Filed: Jan. 21, 2022

Related U.S. Application Data
(60) Provisional application No. 63/140,185, filed on Jan. 21, 2021.

(51) Int. Cl. B05B 12/32; A01G 25/02

(52) U.S. Cl. CPC B05B 12/32; A01G 25/02

(57) ABSTRACT

A shroud for a sprinkler head having a series of removable tabs to allow for configuring a shield-to-shield water distribution from the sprinkler head. The shield has removeable tabs of which allow for water to be sprayed past the shield. The shroud is utilized to configure the distribution of water from a sprinkler head so as, for example, to limit water distribution on unintended or undesired areas. Embodiments of the shroud can be configured to attach by a clip to a sprinkler head, by engagement with a weight threadingly engaged with the sprinkler head, by friction engagement with the sprinkler head, or by alternate attachment. The shroud can be configured in different embodiments to attach to a specific sprinkler head in the industry or configured to attach to different varieties of sprinkler head.

### PRIORITY/CROSS-REFERENCE TO RELATED APPLICATIONS

This application claims the benefit of U.S. Provisional Application No. 63/140185, filed Jan. 21, 2021 the disclosure of which is incorporated by reference.

### TECHNICAL FIELD

The disclosure generally relates to the field of irrigation system accessories. Particularly, the disclosed embodiments relate to shroud devices that may be used on irrigation systems such as pivot line irrigation systems.

### BACKGROUND

The claimed invention relates to irrigation systems for use in agricultural fields or otherwise. Specifically, the invention relates to an accessory that may be readily attachable to irrigation systems already in use to maximize the efficiency of such systems and minimize any potential damage they may cause to the agricultural field.

Irrigation systems have been used since the agricultural revolution several thousand years ago. These systems allow the transport of water to areas where water may otherwise be scarce, limiting the growth potential of the area. In particular, the claimed invention relates to an accessory that may be readily attachable to an irrigation system already deployed in an agricultural field, such as a modern pivot line irrigation system.

The pivot irrigation system is a type of above ground irrigation system that uses a series of large steel pipes coupled with watering hoses. The steel pipes may be rotated on wheels throughout the agricultural field around a fixed point and stationed at different positions throughout. This allows the irrigation system to reach desired sections of the agricultural field without having to have a set system for each section. The watering hoses are attached to the steel pipes at different sections and then hang downwards.

The center pivot irrigation system is a type of irrigation system. In these systems, the steel pipes that are coupled with the watering hoses rotate (or pivot) around a fixed position (the pivot point) in the field. The rotation is automatic and can be constant when in use. Alternatively, the rotation may be intermittent when in use. The rotation is typically achieved through the use of a motor that powers the wheels at each tower point of the irrigation system line. These irrigation systems typically have significant weight.

The watering hoses of both described irrigation systems have a type of sprinkler head attached to the end of them so as to disperse the water in all directions from a fixed central point of the sprinkler head. Examples of these sprinkler heads are found at U.S. Pat. Nos. 6,176,440; 6,932,279; 7,070,122; 7,287,710; 7,562,833; and 8,028,932.

One potential issue with these irrigation systems, in particular with center pivot systems, is that the sprinklers located over the wheels have not been adapted to account for their proximity to the large framing and wheels of the system. The framing and/or wheels will block the dispersion of water being sprayed from the sprinkler heads. This causes the water to accumulate at the base of the wheels, saturating that area of the agricultural field. When the irrigation system is later moved from that location, the saturated areas compress significantly under the weight of the center pivot irrigation system, causing deep ruts in the field.

The ruts created by the irrigation system result in damage to the agricultural field. Also, these ruts can be an impediment to farmers and others working the fields. As the ruts may not be readily visible from a person driving machinery or a vehicle through the field, the person may inadvertently drive over the rut, causing potential for a crash or damage to the vehicle being driven.

### SUMMARY OF THE INVENTION

While certain exemplary embodiments are shown in the Figures and described in this disclosure, it is to be distinctly understood that the presently disclosed inventive concept(s) is not limited thereto but may be variously embodied to practice within the scope of this disclosure. From the following description, it will be apparent that various changes may be made without departing from the spirit and scope of the disclosure as defined herein.

Accordingly, what is disclosed is a shroud that may be readily attached to any desired watering hose and configured to block the water dispersed. In one embodiment of the invention, a shroud may block the sprinkler head from dispersing water preferably up to 180° in any direction, although varying embodiments can be provided. The blocked water is then redirected down the curvature of the shroud thereby increasing the efficiency of the individual sprinkler heads it has been attached to.

The claimed invention relates to sprinkler shroud device. In a first embodiment, the sprinkler shroud device has a shroud with preferably semi-circular shroud body, a top neck, and a top clip or other mechanism for attaching the shroud device to the sprinkler system. The top neck is slimmer at the top portion and gradually expands downward into the semi-circular shroud body. The neck has a diameter to match that of a sprinkler water line or pole that the shroud device is being used on. The top portion of the neck is coupled with the clip. The clip is configured to be removably attachable to a sprinkler water line or other water delivery tube providing water to the sprinkler head.

In a first embodiment, a clip is used to attach the shroud device to the sprinkler. The clip has a front face and a back surface. The front face is open whereas the back surface is preferably formed. The back surface is configured for the attachment to the top portion of the neck of the shroud device. The front face opening of the clip is configured to be removably attachable to a receiving water line or pole. The diameter of the clip is configured to be such that it provides for the secured attachment to the water line or pole that the shroud device is being adopted for use upon.

The shroud body, in a first embodiment, has a defined 180 degree arc with the front forming an open face, although differing design configurations can be used. The open face of the shroud body and the front open face of the clip are oriented so as to be opened in the same direction. Alternatively, the shroud body may be configured to define an arc greater than or less than 180-degrees. The arc of the shroud body is configured such that fluid spray from a sprinkler are deflected out of the open face of the shroud device. The shroud body also has a defined bottom edge, opposite of the clip.

The bottom edge of the shroud body has a perforated edge. The perforated edge is configured to remove sections of attachable tabs from the body. A plurality of tabs that are positioned along the entirety of the perforated edge. Each shroud piece is individually removable and attachable to the perforated edge of the shroud body. This allows an installer to customize the deflection provided by the shroud.

In a second embodiment, the shroud device may be attached at the bottom of a sprinkler head. The shroud device of this embodiment has a shroud body that is preferably circular in shape so as to form a ring. The ring may be of vary dimensions so as to be adopted on varying sprinkler heads.

In this embodiment, the shroud device is configured to attach at the bottom hanging part of the sprinkler head. Preferably, attachment is achieved around the distributor pad of the sprinkler head via friction fitting.

The ring has a top lip where the tabs are attached. The tabs of this second embodiment extend upward from the ring. The tabs deflect the water from the sprinkler head upwards and/or outwards from the sprinkler. Similar to the first embodiment, the tabs of the second embodiment may be individually broken apart so as to configure the deflection arc desired.

In a third disclosed embodiment the shroud is configured to be retained on the sprinkler head by a weight attached to the sprinkler head. Is some sprinkler heads, the sprinkler head utilizes a weight attached to the sprinkler head. The weight is typically attached to the sprinkler head at a lower end of the sprinkler head when the sprinkler head is in a vertical, operating position. The purpose of the weight is to provide weight to the sprinkler head to maintain it in the correct operating position when attached to a sprinkler distribution system, such as a center pivot. The body of the sprinkler is formed as a male threaded section to which a threaded weight, typically in the shape of a hollow disc or ring, is attached. The shroud is configured with a first end having a ring. The ring is configured to be secured to the base by the weight when the weight is threaded onto the sprinkler body.

### BRIEF DESCRIPTION OF THE FIGURES

FIG. 1 illustrates a back isometric view of an embodiment of a sprinkler shroud

FIG. 2 illustrates a first side view of an embodiment of a sprinkler shroud

FIG. 3 illustrates a top view of an embodiment of a sprinkler shroud device.

FIG. 4 illustrates a perspective view of an embodiment of a sprinkler shroud device.

FIG. 5 illustrates a preferred embodiment of a sprinkler shroud device.

FIG. 6 illustrates the preferred embodiment of a sprinkler shroud device of FIG. 5 attached to a sprinkler head.

FIG. 7 illustrates the device of FIGS. 4-6 attached to a sprinkler head with the sprinkler head operating.

FIG. 8 illustrates a second preferred embodiment sprinkler shroud device

FIG. 9 illustrates a top view of the sprinkler shroud device of FIG. 8.

FIG. 10 illustrates a side view of a sprinkler shroud divide of FIGS. 8-9

FIG. 11 illustrates the sprinkler shroud device of FIGS. 8-10 attached to a sprinkler head

FIG. 12 illustrates a second side view of the sprinkler shroud device of FIGS. 8-11 attached to a sprinkler head

FIG. 13 illustrates a third side perspective of a sprinkler shroud device of FIGS. 8-12 attached to sprinkler head

### DETAILED DESCRIPTION OF THE FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

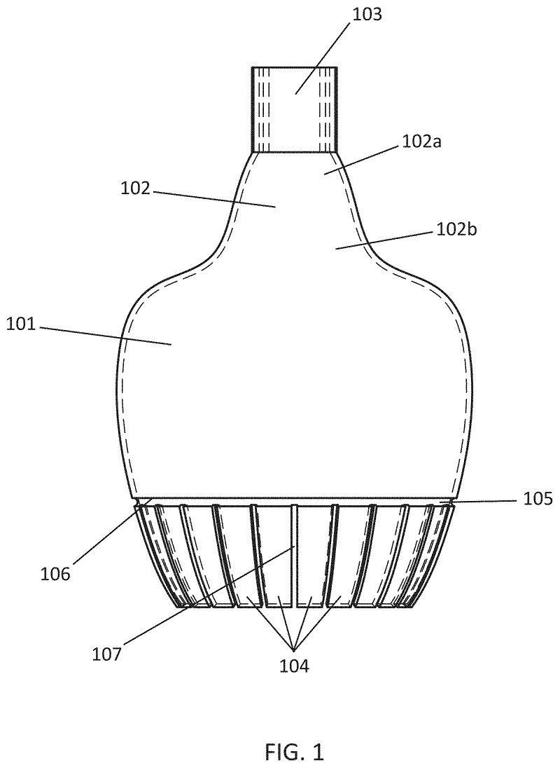

FIG. 1 illustrates a back view of a first embodiment. FIG. 1 shows the shroud device 1 having a shroud body 101. The shroud body has a top portion defined by a neck 102. The neck 102 is narrow 102a at the top and gradually expands outward 102b as it forms into the shroud body 101. The neck 102 may also be uniform in size and be configured to attach to the shroud body 101. The neck 102 may also be configured such that it is an extension of the shroud body as a whole. The top of the neck 102 is configured to be coupled with a clip 103.

A series of tabs 104 are connected to the shroud at a perforated edge 105. The perforated edge 105 is configured for individual tabs 104 to be removed from the shroud body 101 around the defined bottom edge 106.

The tabs may be individually detached from the shroud body. The perforations of the tabs is configured to withstand the power of a spraying fluid from a sprinkler line or sprinkler head, but to provide the ability of the installer to cut or break away the tabs. When all tabs are attached, the bottom edge 106 of the shroud body 101 has a completed 180-degree arc 107 of tabs 104. Additionally, the tabs 104 being individually attached/detached, the arc 107 may range from 0 degrees up to and including the 180 degrees. In other embodiments, the shroud body 101 has an arc 301 larger than 180-degrees, the arc 107 formed by the tabs may also be larger than 180-degrees. The maximum arc of the tabs is configured to match the arc of the shroud body.

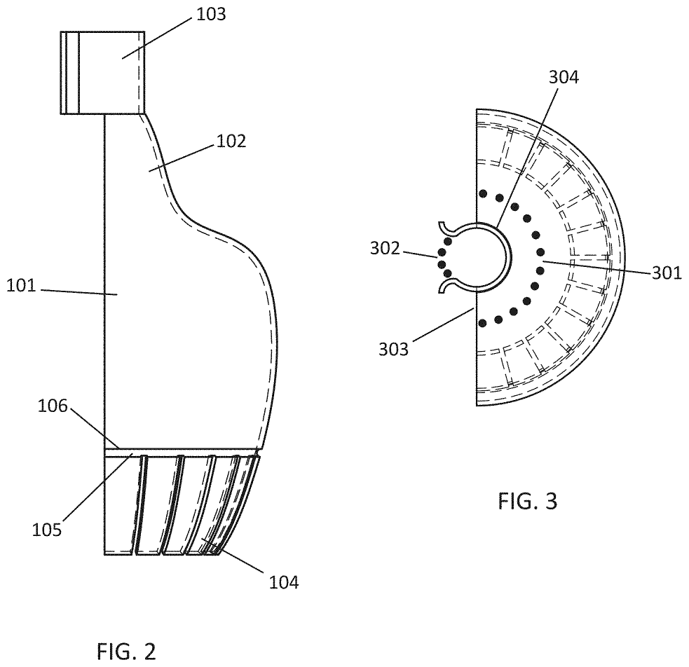

FIG. 2 illustrates a side view of a first embodiment of the sprinkler shroud device. FIG. 2 illustrates the clip 103 as coupled to the neck 102 at the top of the shroud. Further illustrated in FIG. 2 is the shroud body 101. The perforated edge 105 at the bottom edge 106 of the shroud body 101 is depicted. Approximately half of the tabs 104 have been detached from the shroud body 101.

FIG. 3 illustrates a top view of the shroud device. FIG. 3 illustrates the shroud body 101 having a defined 180 degree arc 301. The shroud body 101, alternatively, may define an arc that is larger than 180-degrees but less than 360-degrees, or less than 180-degrees. The body has an open face 303. The open face 303 is opposite from the 180-arc 301 of shroud body 101. The open face 303 is oriented so as to align with the front open face 302 of the clip 103.

Further illustrated in FIG. 3 is an embodiment of a clip 103. As illustrated, the clip 103 has a front open face 302. The front open face 302 is configured for attachment to a sprinkler line or pole. The front open face 302 of the clip 103 is slightly narrower than the back face 304 of the clip to provide for secure attachment around a sprinkler line or pole. The clip 103 may be attached using a strap or other type of securing device.

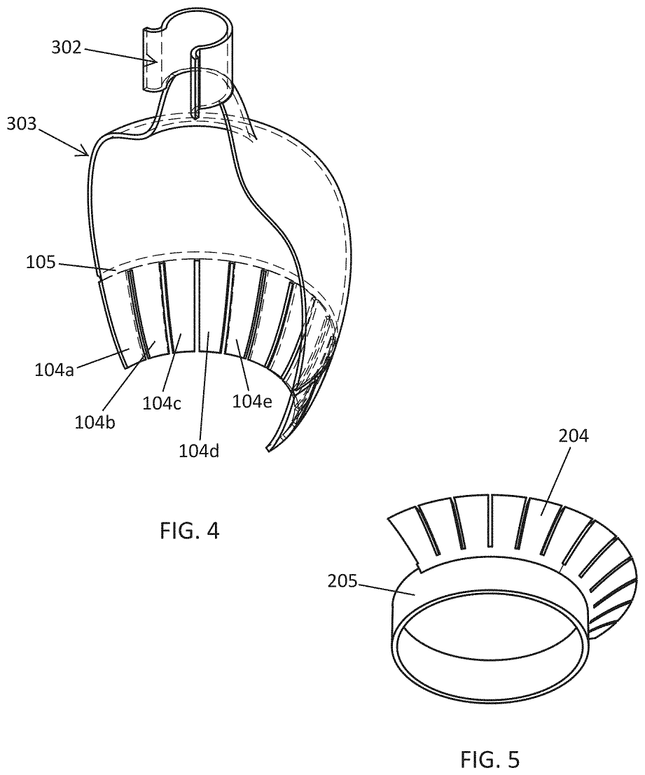

FIG. 4 illustrates an angled front view of the first embodiment. As illustrated, there is a clip 103 coupled to the top portion of the neck 102. The front open face 302 is oriented in the same direction as the open face 303 of the shroud body 101. The neck gradually expands downward into the shroud body 101. FIG. 4 gives a better view of the curvature of the shroud body 101. The curvature of the shroud body 101 is configured such that the spray of fluid will be deflected outwards through the open face 303 of the shroud body 101. FIG. 4 shows the individual tabs 104a-104e. The tabs 104 can be individually separated and removed from the shroud device. The tabs 104 are configured for detachment at the perforated edge 105. The tabs may vary in size.

Alternatively, in a different embodiment, the tabs may be individually attachable at the bottom edge of the shroud body. This would allow an installer to customize an individual shroud device more than one time.

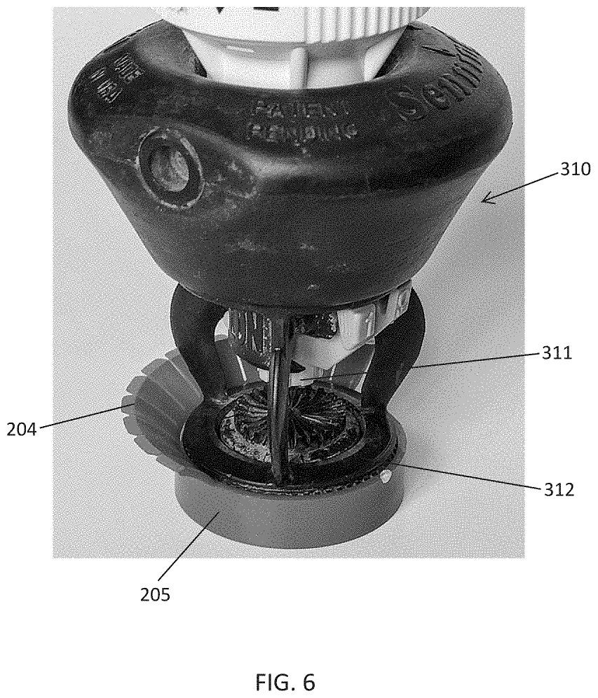

FIGS. 5 and 6 illustrate a second embodiment of the shroud device. As illustrated, the shroud device has body that is configured to be in the shape of a ring 205. The ring 205 is configured for attachment to the bottom part of a sprinkler head. Attachment is preferably achieved via friction fitting. Preferably, the ring 205 attaches around the distributor pad 312 of a sprinkler head 310. The ring 205 is of a variable dimensions so as to securely fit the sprinkler head being used on. The diameter of the ring 205 may vary with the sprinkler head being used on. Additionally, the height of the ring 205 may vary with the sprinkler head being used on.

Further illustrated in FIGS. 5 and 6 are the tabs 204. The tabs 204 of the second embodiment are directed upwards from the ring 205. The tabs 204 are attached around the ring on the top lip. The tabs 204 deflect fluid from a sprinkler head nozzle 311 upwards and/or outwards from the sprinkler head. The tabs 204 may be individually detached from the ring 205.

Alternatively, in a different embodiment, the tabs may be individually attachable at the top lip of the ring. This would allow an installer to customize an individual shroud device more than one time.

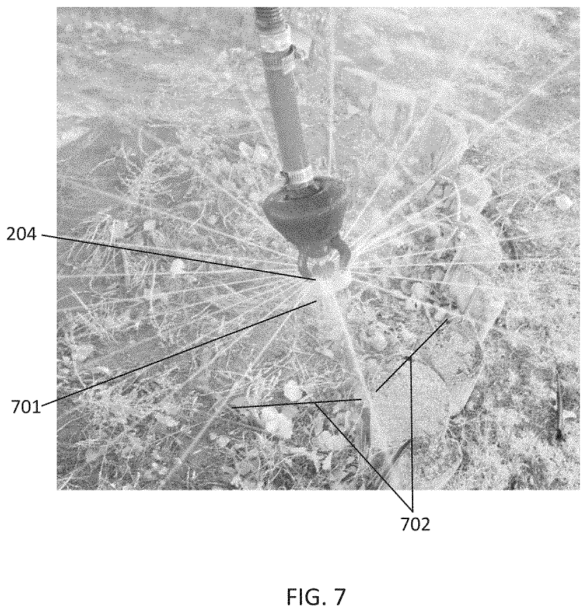

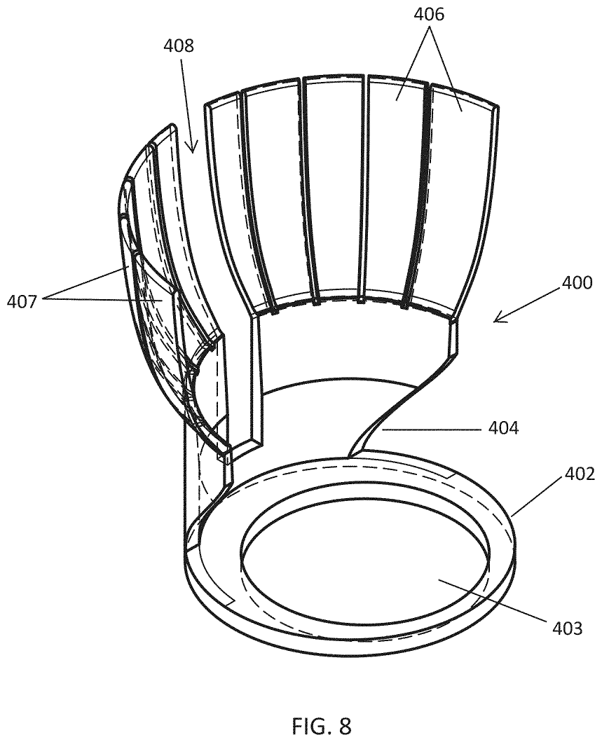

FIG. 7 illustrates the second embodiment in use on a sprinkler head. The tab 204 deflects 701 the fluid spraying out of the sprinkler head. This is evidenced by the absence of fluid spray indicated by the lines at 702. The tabs 204 may be individually detached from the ring 205 so as to create a customized fluid spray pattern, as illustrated in FIG. 7.

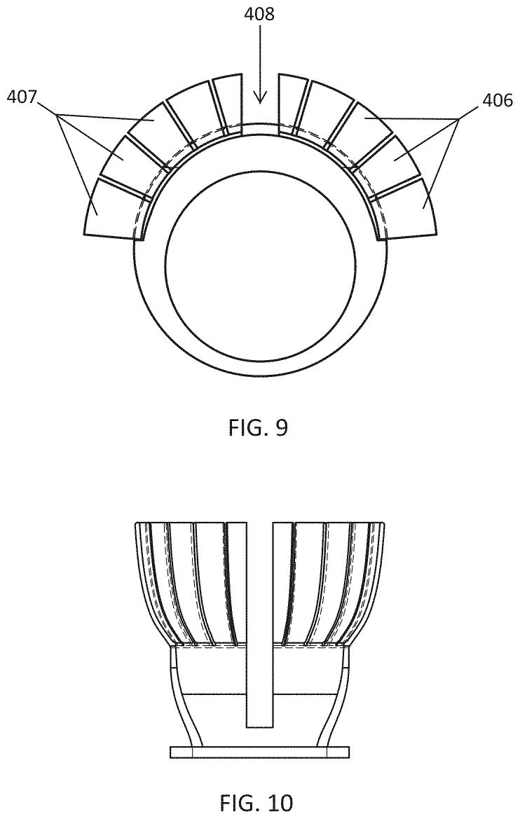

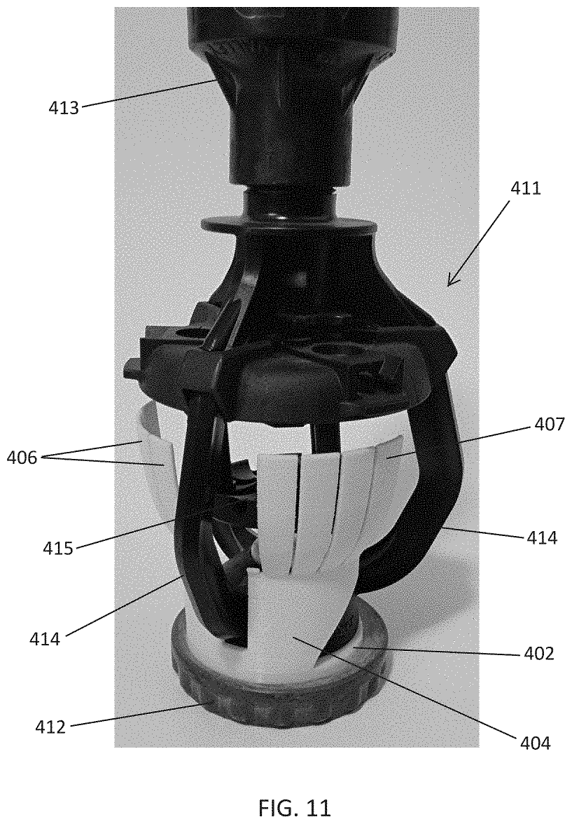

FIG. 8 illustrates an embodiment of a sprinkler shroud having detachable tabs 406, 407 connected to a neck, 404 that extends from a base that is formed in a ring 402. The ring of the base 402 defines an opening 403. The opening 403 is configured such that the bottom section a sprinkler can be positioned through the ring. These sprinkler heads generally utilize a weight that is threadedly or clippingly attached to the sprinkler. This weight serves to secure the shroud to the sprinkler as shown in FIGS. 11-13. The tabs 406,407 are provided in two separate groups that are separated by a gap, 408. The gap 408 is configured for a leg of the sprinkler to be positioned between the two groups of tabs. The embodiment is configured to attach via the ring at the base of the sprinkler head and extend vertically upward to the top of a hanging sprinkler head.

FIG. 9 illustrates a top isometric view of the preferred embodiment of the sprinkler head of FIG. 8. The opposing groupings of tabs 407, 408 are provided. The shroud is configured to be adjustable relative to the sprinkler head. This allows the shroud to be rotated around the vertical access of the sprinkler head. FIG. 11 illustrates the embodiment of the sprinkler shroud of FIGS. 8-10 connected to a sprinkler head. The sprinkler head 403 is shown in a vertical hanging orientation. The sprinkler head is typically connected to a source of water for 413. The water is sprayed downward from a tube not shown onto a distribution disk 415 and emanated outwards as shown in FIG. 7. The distribution disk 415 is supported in a spaced apart arrangement by legs 414 which suspend the lower portion of the sprinkler head from the distribution tube and source of in-flow water. A weight 412 is connected to the sprinkler head at the base of the sprinkler head. This weight is typically connected via a threaded or clip-on engagement. The sprinkler shroud illustrated shows a ring 402 supported by the weight 412. To install this depicted embodiment of the shroud, the weight is removed, the ring is positioned over the threads and the weight is re-installed via threaded engagement to support the shroud.

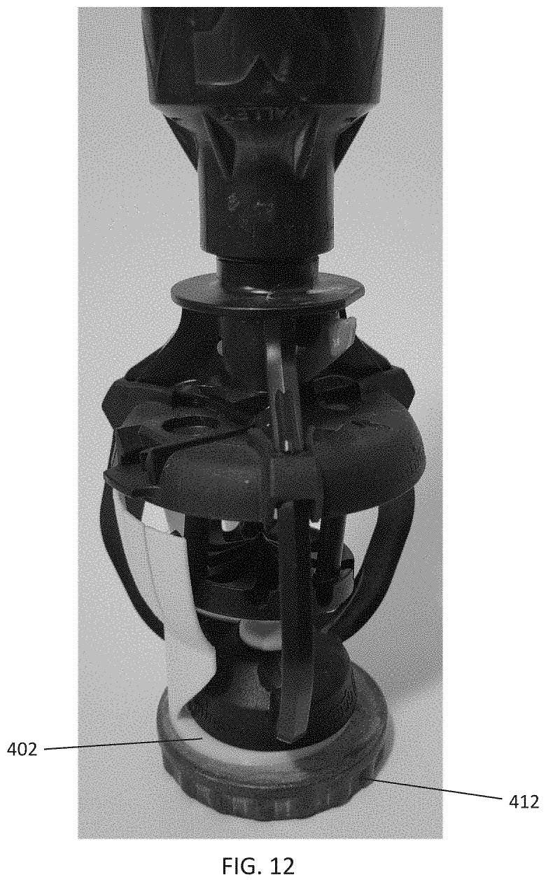

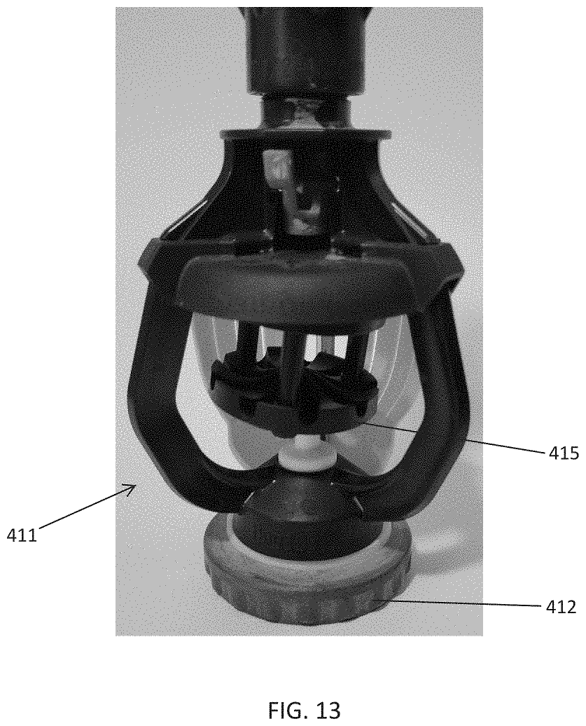

FIGS. 12 and 13 depict alternate side views of the sprinkler shroud and sprinkler head. FIG. 13 illustrates the distribution disk of the sprinkler head relative to the body of the sprinkler head 411.

Still other features and advantages of the presently disclosed and claimed inventive concept(s) will become readily apparent to those skilled in this art from the following detailed description describing preferred embodiments of the inventive concept(s), simply by way of illustration of the embodiments contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

I claim:

1. A sprinkler head shroud, said sprinkler head shroud comprising:
a body comprising a first end configured for attachment to a sprinkler head;
a plurality of tabs connected to a second end of said body, wherein said plurality of tabs are configured to extend from said second end of said body such that said plurality of tabs are configured to interfere with water distribution from said sprinkler head when said shroud is attached to the sprinkler head, wherein said plurality of tabs are configured for independent removal to increase decrease interference with water distribution from said sprinkler head when said plurality of tabs are removed.

2. The sprinkler head shroud of claim 1, wherein each tab of said plurality of tabs is separated from each neighboring tab by a perforation.

3. The sprinkler head shroud of claim 1, wherein said plurality of tabs are each configured to be cut to remove said tabs from said sprinkler head shroud.

4. The sprinkler head shroud of claim 1, wherein said body is configured for attachment to a sprinkler head by a clip.

5. The sprinkler head shroud of claim 1, wherein said body is configured for attachment to a sprinkler head by a ring, wherein said ring is configured to be connected to a sprinkler head by a weight attached to said sprinkler head.

6. The sprinkler head shroud of claim 1, wherein said plurality of tabs are arranged in two groups of tabs, wherein said groups of tabs are separated be a gap.

7. A sprinkler head shroud, said sprinkler head shroud comprising:
a shroud body having a top and bottom end separated by a main body, wherein said top end is configured for attachment to a water delivery tube of a pivot irrigation system,
wherein said main body is configured to positionally surround a sprinkler head, so as to deflect water spray from said sprinkler head;
wherein said second end comprises a series of removable tabs configured such that removal of one of said tabs causes a reduction in said shroud blocking water distributed from the sprinkler head.

8. The sprinkler head shroud of claim 7, wherein said bottom end has a perforated edge.

9. The sprinkler head shroud of claim 7, wherein said tabs are connected to said main body at a perforated edge.

10. The sprinkler head shroud of claim 7, wherein said main body has a 180-degree arc.

11. The sprinkler head shroud of claim 10, wherein said main body has an open face.

12. The sprinkler head shroud of claim 7, wherein said top end has a clip configured to attach to a water delivery tube.

13. The sprinkler head shroud of claim 12, wherein said clip has a front face and a back surface wherein said front face is open and said back surface is completely formed.

14. The sprinkler head shroud of claim 7, wherein said tabs are connected to neighboring tabs by perforation.

15. The sprinkler head shroud of claim 7 wherein said tabs are numerous.

16. The device of claim 7, wherein said tabs are configured to be individually removed from said bottom end.

17. A sprinkler head shroud, said shroud comprising:
a shroud body having ring, wherein said ring is configured to attach to a sprinkler head, wherein said ring has a top lip, wherein said top lip comprises a series of removable tabs configured such that removal of one of said tabs causes a reduction in said shroud blocking water distributed from the sprinkler head.

18. The device of claim 17 wherein said ring is attached via friction fitting.
